(19) United States
(12) Patent Application Publication
(10) Pub. No.: US 2014/0274228 A1
(43) Pub. Date: Sep. 18, 2014

(54) PORTABLE STAND FOR MOBILE ELECTRONIC DEVICES

(71) Applicants: King Leung WONG, Richmond Hill (CA); Luk Kan WONG, Richmond Hill (CA)

(72) Inventors: King Leung WONG, Richmond Hill (CA); Luk Kan WONG, Richmond Hill (CA)

(21) Appl. No.: 13/828,395

(22) Filed: Mar. 14, 2013

(51) Int. Cl. H04M 1/02

(52) U.S. Cl. CPC H04M 1/026
USPC 455/575.1

(57) ABSTRACT

This invention provides portable stands for cell phones/tablets/mobile electronic devices having at least one receptacle for power and/or an earphone/headset. The portable stand includes a support leg for supporting the electronic device on a surface, the support leg having a proximal end and a distal end, the distal end being configured to engage with a surface on which the mobile device is being supported. The stand includes a clasping means for releasably attaching the support leg to the electronic device. The clasping means extends from the proximal end of the support leg and is configured to be engaged with a connector plug inserted into the receptacle of the electronic device.

### FIELD

The present disclosure relates to a portable stand for mobile electronic devices, in particular, to a portable stand for cell phones, smart phones, tablets, and hand held electronic devices.

### BACKGROUND

Tablets, smartphones, cell phones, in addition to providing the functionality of a phone, are also used for browsing the web, displaying photographs and playing music. In many instances it would be desirable to mount the cell phone in a stand to allow the operator to free their hands. Current stands are bulky and in addition to serving to act as a stand they provide a charging functionality to charge the cell phone. Such stands are not convenient for those situations where the owner of the cell phone is away from the charging stand and have a need for a portable stand that is lightweight, small, readily transportable and can be easily engaged with the cell phone to hold it either in a vertical or inclined position for easy viewing of the cell phone screen.

Thus it would be very advantageous to provide a lightweight, small, readily transportable stand for mobile electronic devices.

### SUMMARY

Disclosed herein are portable stands for mobile electronic devices, whose non-limiting examples include cell phones, smart phones, tablets, personal digital assistants (PDA), and other hand held electronic devices.

A feature of the present device is that it leverages/uses the headset plug or the power plug or any kind of plug to the device for constructing a stand.

In an embodiment there is provided a portable stand for a mobile electronic device having at least one receptacle for power and/or an earphone/headset, said portable stand comprising:

a support leg for supporting the electronic device on a surface, said support leg having a proximal end and a distal end, said distal end configured to engage with a surface on which the mobile device is being supported; and

clasping means for releasably attaching the support leg to the electronic device,

said clasping means extending from the proximal end of said support leg and configured to be engaged with a connector plug inserted into the receptacle of the electronic device.

There is also provided a portable stand for a mobile electronic device having at least one receptacle for power and/or an earphone/headset, said portable stand comprising:

a dummy plug configured for insertion into the receptacle of the electronic device,

a support leg for supporting the electronic device on a surface, said support leg having a proximal end and a distal end, said distal end configured to engage a surface on which the mobile electronic device is being supported; and

clasping means extending from the proximal end of the support leg, and configured for releasable engagement with the dummy plug.

A further understanding of the functional and advantageous aspects of the invention can be realized by reference to the following detailed description.

### BRIEF DESCRIPTION OF DRAWINGS

The following is a description of embodiments of portable stands for mobile electronic devices, constructed in accordance with the present invention, reference being had to the accompanying drawings, in which:

FIG. 1 is a perspective disassembled view of a mobile device and an embodiment of the present portable mobile device stand;

FIG. 2 is a perspective view of the mobile device and assembled with the stand of FIG. 1;

FIG. 3 is an end view of the mobile device supported by the stand in FIGS. 1 and 2 taken along arrow 3 of FIG. 2;

FIG. 4 is a perspective disassembled view of a mobile device and a second embodiment of a present portable mobile device stand;

FIG. 5 is a perspective disassembled view of a mobile device and a third embodiment of a present portable mobile device stand;

FIG. 6 is a perspective disassembled view of a mobile device and a fourth embodiment of a present portable mobile device stand;

FIG. 7 is a perspective disassembled view of a mobile device and a fifth embodiment of a portable mobile device stand;

FIG. 8 is a perspective view of the mobile device assembled with the fifth embodiment of the portable mobile device stand shown in FIG. 7;

FIG. 9 is a view seen from the front of the mobile device assembled with the fifth embodiment of the stand shown in FIG. 8; and

FIG. 10 is a perspective disassembled view of a mobile device and a sixth embodiment of a portable mobile device stand.

### DETAILED DESCRIPTION

Generally speaking, the embodiments described herein are directed to portable stands for mobile electronic devices, including, but not limited to, cell phones, smart phones, tablets, personal digital assistants (PDA), and other hand held electronic devices. As required, embodiments of the present invention are disclosed herein. However, the disclosed embodiments are merely exemplary, and it should be understood that the invention may be embodied in many various and alternative forms. Thus, for purposes of teaching and not limitation, the illustrated embodiments are directed to portable stands for mobile electronic devices.

Various embodiments and aspects of the disclosure will be described with reference to details discussed below. The following description and drawings are illustrative of the disclosure and are not to be construed as limiting the disclosure. The drawings are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the terms “example”, “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

As used herein the expressions cell phones/smartphones/mobile phones/tablets/PDAs are not restricted to any particular type of cell phones/smartphones/mobile phones/tablets/PDAs, and are applicable to all mobile electronic devices having any kind of power port/receptacles for charging the device and/or an earphone jack for plugging in a pair of ear phones.

The present invention relates to a lightweight, portable and easy to carry support stand that makes use of any power port for charging the device and/or an earphone jack for plugging in a pair of ear phones and/or any plug/jack on the mobile device.

Referring first to FIGS. 1 and 2, there is shown generally at 10 a mobile device 12 and a stand 14. As noted above, mobile device 12 may for example be any model of cell phone having one or both of a power port (not shown) for charging the cell phone and/or an earphone receptacle 28 for plugging in a pair of ear phones. Cell phone stand 14 includes an elongate leg section 16 and a short elongate foot section 18 at the distal end of leg section 16 and which is perpendicular to leg section 16, but it will be appreciated in does not have to perpendicular, it could be a smaller or larger angle than 90 degrees and still provide support. Stand 14 includes a clasp 22 located at the proximal end of leg section 16 curved rod section 20 having a curvature that is designed to mate to a curved peripheral edge of cell phone 12. Clasp 22 and curved section 20 are clipped/held onto cylindrical section 26 of plug 24 and curved section 20 is designed to prevent the stand 14 from rotating/spinning on receptacle 28 so that clasp 22 and curved section 20 operate together to secure the position of the stand 14 on the device 12. In another variation of the design the curved section 20 may be configured to wrap around the front of the device rather than bearing on the back of device 12 which serves the same purpose of secure the position of stand 14 on device 12.

Stand 14 includes a dummy headphone plug 24 which includes a section 27 having the same diameter as the insertable portion of a real earphone jack that is plugged into receptacle 28 on cell phone 12. Dummy jack 24 includes a larger diameter section 26 which is clasped by clasp 22. Clasp 22 may be clipped/held on to various size of the earphone/headset plug. Clasp 22 is not limited to a clip design as shown in the Figures, it may be any form or mechanism to clip/grip/hold onto the earphone/headset plug or the power plug/jack. Another embodiment may include a flexible wire-based design having a long flexible leg section and one end of the flexible wire having one or two coils to wrap around section 26 of the plug 24 with a short wire ended like section 20.

In operation, the user inserts dummy plug 24 into receptacle 28 of cell phone 12, and the clasp 22 is engaged with section 26 of plug 24 with arcuate section 20 bearing against the edge of cell phone 12. Referring to FIG. 3, foot section 18 is rested on the support surface with the lower edge of phone 12 on the support surface as well. This provides a way of supporting cell phone 12 at an angle with respect to the support surface, and this angle can be adjusted as shown in FIG. 3 by bending or rotating elongate leg section 16 of stand 14 with respect to dummy plug 24.

While portable stand 14 may be sold as a kit including both elongate leg section 16, foot section 18 and clasp 22 all formed as a single unit along with dummy plug 24, it will be appreciated that clasp 22 can be configured to clasp a section of the earphone plug so that in some cases dummy plug 24 may not be required. A situation where this would be the case is if the user is supporting cell phone 12 to watch the video screen and is listening to the video sound through the earphone at the same time.

In another embodiment of the stand 14 the lower foot section 18 may be omitted so that only elongate leg 16 is present which can also function as a stand. Elongate leg 16 may be made of a flexible material so it may be bent in any direction to support device 12 at a desirable angle.

Referring to FIG. 4, another embodiment of the portable and lightweight cell phone stand 40 with the cell phone 12 is shown. Stand 40 includes a flexible elongate leg section having a clasp 42 located at its proximal end which clasps section 26 of dummy ear phone plug 24. Stand 40 functions in the same way as stand 14 with a difference being the use of a slightly different clasp for holding onto section 26 of a jack/plug 24.

FIG. 5 shows another embodiment of a portable stand 50 which includes the same dummy plug 24 and a support structure is comprised of a first elongate section 54 which provides support for the back of the cell phone 12 when engaged with the cell phone, a second elongate section 52 which is perpendicular to section 54 and engages the support surface on which cell phone 12 is located. Clasp 22 is located at the proximal end of the support structure and engages surface 26 of dummy plug 24 as in the previous embodiments described above. The stand 50 of FIG. 5 is useful for providing support for larger devices such as a tablet. The arrows show both legs sections 52 and 54 can be bent or rotated in all directions for supporting the device 12 for supporting it at a desired position.

FIG. 6 shows a variation of the embodiment of FIG. 5 in which the support stand structure 60 is similar to structure 50 in FIG. 5, but includes a lower leg section 64 continuous with an upper leg section 62 with leg section 66 parallel to lower section 64 which supports the back side of cell phone 12. Support structure 60 is similarly designed to support larger devices such as tablets with the arrows showing both legs 62 and 64 can be bent or rotated in all direction for supporting the device for standing at a desired position.

FIGS. 7 and 8 shows another embodiment of a stand 68 which includes an elongate leg 70 which is made of a flexible material such that a user may bend the shape of leg 70 to whatever shape they require for the given support configuration required. The material is strong enough to form a stand and support the device 12 for standing at a desired position. At the proximal end of leg 70 is located a flange portion 72 to which advertising may be attached. Flange 72 may be pivotally attached to the end of leg 70 so it can be pivoted into position to engage it with the back side of device 12 when used to support device 12 and pivoted out of engagement with device 12 when not be used to support it. Stand 68 includes a clasp section 32 which can receive therein a cylindrical body portion 36 of a plug 34. Plug 34 includes an active plug in section 40 which makes electrical contact when plugged into receptacle 28 and plug 34 includes a port 38 to receive therein an earphone jack 76 shown in FIG. 9. The interior of plug 34 is wired to make electrical contact between jack 76 and the device 12 through the electrical connections of plug in section 40.

FIG. 7 shows the support leg 70 engaged with plug 34 while FIG. 8 shows the stand 68 engaged with the cell phone 12. FIG. 9 shows the stand of FIG. 8 showing flange 72, to which the logo is attached, flipped down to lock the position of the stand 68 to device 12, and earphone jack 76 positioned to be plugged into port 38. Without the flange 72 flipped down, the stand 68 could spin on the plug 34 and would not hold the device 12 standing properly.

FIG. 10 shows another embodiment of a portable lightweight cell phone stand 80 which includes an elongate bracket 86 having a track 87 running along its length. Stand 80 includes an elongate leg composed of two telescoping sections 82 and 84 which allows the length of the leg to be adjusted. The proximal end leg section 82 is pivotally mounted to a bracket 88 which is mounted in, and can slide along in, track 87 and to adjust the position of the telescoping leg along the back surface of cell phone 12. A clasp 90 is attached to one end of bracket 86 which is to grip a power plug 94 which may be of any size which is inserted into the power receptacle 92 or the earphone receptacle of the cell phone 12 (as in FIG. 1). Alternatively the support structure may include a dummy power plug which plugs into the power receptacle 92, similar to dummy earphone plug 24 of the above discussed embodiments. Clasp 22 and clasp 90 may be a generic clasp designed to clip onto any plug (earphone plug or power plug or any other type of plug).

The stand 80 provides a more rigid/mechanical design compared to the other embodiments instead of bending the legs, it allows the length of leg 82/84 to be shortened or elongated and to allow it to slide along track 87.

The foregoing description of the preferred embodiments of the invention has been presented to illustrate the principles of the invention and not to limit the invention to the particular embodiments illustrated. It is intended that the scope of the invention be defined by all of the embodiments encompassed within the following claims and their equivalents.

Therefore, what is claimed is:

1. A portable stand for a mobile electronic device having at least one receptacle for power and/or an earphone/headset, said portable stand comprising:
a support leg for supporting the electronic device on a surface, said support leg having a proximal end and a distal end, said distal end configured to engage with a surface on which the mobile device is being supported; and
clasping means for releasably attaching the support leg to the electronic device,
said clasping means extending from the proximal end of said support leg and configured to be engaged with a connector plug inserted into the receptacle of the electronic device.

2. The portable stand according to claim 1, wherein the connector plug is one of a power plug, headset/earphone plug, and a dummy plug.

3. The portable stand according to claim 2, wherein said support leg is configured for rotatable engagement with the connector plug for adjusting an angle of the mobile device with respect to the surface on which it is supported.

4. The portable stand according to claim 3, wherein said support leg further includes a foot section extending from the distal end at an angle smaller or larger than 90 degrees.

5. The portable stand according to claim 3, wherein said support leg is an upper support leg, including a lower support foot extending from, and generally perpendicular to, said upper support leg.

6. The portable stand according to claim 5, wherein said support leg further comprises an elongate bar extending from said proximal end of the support leg, said elongate bar extending generally parallel to said lower support leg and configured to engage a back surface of the mobile device along its length.

7. The portable stand according to claim 2, wherein said support leg comprises two telescoping sections for adjusting a length of said support leg.

8. The portable stand according to claim 7, further including a bracket having a track formed therein, and wherein the proximal end of the support leg is pivotally mounted within the track, and said clasping means extends from the back of the bracket.

9. The portable stand according to claim 2, wherein said support leg is made of bendable material.

10. The portable stand according to claim 9, wherein said clasping means is a cylindrical tube configured for receiving a larger diameter portion of the plug.

11. The portable stand according to claim 10, wherein the support leg further comprises a flange located upstream of the cylindrical tube, said flange having a surface for markings selected from pictorial marking, written markings, and a combination thereof.

12. A portable stand for a mobile electronic device having at least one receptacle for power and/or an earphone/headset, said portable stand comprising:
a dummy plug configured for insertion into the receptacle of the electronic device,
a support leg for supporting the electronic device on a surface, said support leg having a proximal end and a distal end, said distal end configured to engage a surface on which the mobile electronic device is being supported; and
clasping means extending from the proximal end of the support leg, and configured for releasable engagement with the dummy plug.

13. The portable stand according to claim 12, wherein the dummy plug comprises a smaller diameter section for insertion into the receptacle and a larger diameter section for engagement with the clasping means.

14. The portable stand according to claim 13, wherein the larger diameter section of the dummy plug further comprises an aperture at a distal end, for engagement with an electrical plug selected from the group consisting of a power plug and an earphone plug.

15. The portable stand according to claim 12, wherein said support leg is configured for rotatable engagement with the connector plug.

16. The portable stand according to claim 12, wherein said support leg is made of bendable material.

17. The portable stand according to claim 16, wherein said clasping means is a cylindrical tube configured for receiving a larger diameter section of the dummy plug.

18. The portable stand according to claim 17, wherein the support leg further comprises a flange located upstream of the cylindrical tube, said flange having a surface for markings selected from pictorial marking, written markings, and a combination thereof.

19. The portable stand according to claim 12, wherein said support leg comprises two telescoping sections for adjusting the length of the support leg.

20. The portable stand according to claim 19, further including a bracket having a track formed therein, and wherein the proximal end of the support leg is pivotally mounted within the track and is slidably movable in said track, and said clasping means extends from the back of the bracket.
